(19) United States
(12) Patent Application Publication
(10) Pub. No.: US 2004/0259573 A1
(43) Pub. Date: Dec. 23, 2004

(54) System and method for providing position alerting with a mobile device

(76) Inventor: Steven D. Cheng, San Diego, CA (US)

Correspondence Address: NAIPO (NORTH AMERICA INTERNATIONAL PATENT OFFICE), P.O. BOX 506, MERRIFIELD, VA, 22116, US

(21) Appl. No.: 10/250,284

(22) Filed: Jun. 20, 2003

(51) Int. Cl. H04Q 7/20

(52) U.S. Cl. 455/456.3; 455/456.1

(57) ABSTRACT

A cellular device connects with a network of base stations. Each base station covers a corresponding service area, and broadcasts unique identifying information in a standard manner. A portable computing platform is used as a POI database and server for the cellular device, and establishes a communications link with the cellular device. A trip scheduler is provided in the cellular device that interfaces with the POI database server over the communications link to enable a user to extract POI data from the POI database. The POI data includes a POI identifier for a POI, and a related base station identifier that uniquely identifies a target base station having a service area that covers the POI. The cellular device monitors base stations to determine when the cellular device enters into the service area of the target base station, and then provides an alert to the user indicative of the POI.

### BACKGROUND OF INVENTION

1. Field of the Invention

The present invention relates to providing positioning services. More specifically, utilization of standard services provided by cellular telephone networks is disclosed that enables a user to navigate between various points of interest.

2. Description of the Prior Art

With an increasingly mobile population, coupled with the perception of lifestyles becoming more and more busy, there is a growing demand to provide users with cheap and convenient positioning systems that will enable these users to determine not only where they are, but also what is of interest around them.

On any excursion, a user may have one or more points of interest (POI) that are to be visited. For example, a user may desire to go to the bank, a gas station, buy groceries, visit a land mark, etc. For each of these tasks, the user may have a specific locale in mind. For some of these tasks, an alternate site might work as well as the one originally planned by the user. In the hustle and bustle of trying to get from one point to another, a user may become disoriented, or forget to visit a nearby POI.

Several suggestions have been proposed to assist in determining the geographical location of a user of a mobile telephone. Reference is drawn, for example, to U.S. Pat. No. 6,311,069 to Havinis, et al.; U.S. Pat. No. 6,421,602 to Bullock, et al.; and U.S. Pat. No. 6,342,864 to Duffett-Smith, et al., as examples. All of these approaches, however, rely upon positioning information being obtained from Global Positioning System (GPS) equipment, or from subscription to a special service provided by the mobile network system. As such, these inventions incur added expense to the user.

### SUMMARY OF INVENTION

It is therefore a primary objective of this invention to provide position tracking and associated point of interest (POI) alerting for a user, without requiring specialized geographic tracking hardware or subscription to specialized tracking services.

Briefly summarized, the preferred embodiment of the present invention discloses a method and related system for providing point of interest (POI) alerting to a user of a cellular device. The cellular device is capable of connecting with a network of base stations. Each base station covers a corresponding service area, and broadcasts unique identifying information in a standard manner. A portable computing platform is used as a POI database and server for the cellular device, and establishes a communications link with the cellular device. A trip scheduler is provided in the cellular device that interfaces with the POI database server over the communications link to enable a user to extract POI data from the POI database. The POI data includes a POI identifier for a POI, and a related base station identifier that uniquely identifies a base station having a service area that covers the POI. The cellular device monitors base stations to determine when the cellular device enters into the service area of the base station, and then provides an alert to the user indicative of the POI.

It is an advantage of the present invention that the cellular device uses standard information transmitted by all base stations to determine an approximate geographical area of the location of the cellular device. The present invention can be fully implemented in software on a standard cellular device, and thus does not require subscription to specialized services, or dedicated positioning hardware. The present invention can thus be implemented in a relatively inexpensive manner, without incurring subscription service costs.

It is a further advantage that a portable computing platform is used as a POI server, which reduces the memory requirements for POI services on the cellular device.

These and other objectives of the present invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 depicts a preferred embodiment arrangement of the present invention.

FIG. 2 is a block diagram of a first embodiment of the arrangement depicted in FIG. 1.

FIG. 3 is a map of a hypothetical region with superimposed base station service areas.

FIG. 4 illustrates a portion of a point of interest (POI) central database depicted in FIG. 2 corresponding to the map of FIG. 3.

FIG. 5 is a detailed block diagram of POI data from FIG. 2.

FIG. 6 is a block diagram of example POI data generated by a trip scheduler of FIG. 2 according to the map depicted in FIG. 3.

### DETAILED DESCRIPTION

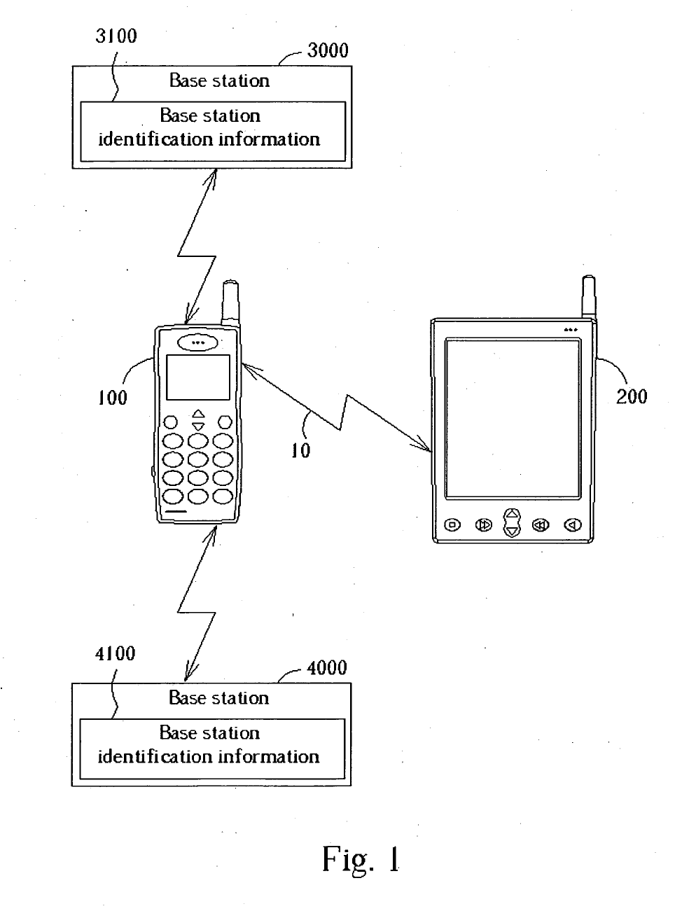

Please refer to FIG. 1. FIG. 1 depicts a preferred embodiment arrangement of the present invention. The preferred embodiment arrangement of the present invention utilizes as a cellular device a mobile telephone 100 that is in communications with a portable computing platform, in this case a personal data assistant (PDA) 200. Other computing devices could be substituted in place of the PDA 200, such as a laptop computer or a tablet PC. The functionality required of the portable computing device, as served by the PDA 200, should become clear after reading the following detailed description, and hence suitable substitutes to the PDA 200 should also become clear to one reasonably skilled in the art. This also holds true for the mobile telephone 100. Communications between the mobile telephone 100 and the PDA 200 is effected by way of a communications link 10. The communications link 10 may be a wired or wireless link. Examples of wireless links include Bluetooth and Infrared (IR) links. The most common wired links are Universal Serial Bus (USB) and IEEE 1394 (FireWire). Other types of links are certainly possible, though, so long as the communications link 10 enables satisfactory communications between the mobile telephone 100 and the PDA 200 as described in the following.

As a basic operating premise of the present invention, the PDA 200 is used as a point of interest (POI) database server, while the mobile telephone 100 is used to determine a service area in which the mobile telephone 100 (and hence the user) is currently located. A user may select one or more POIs from a POI database on the PDA 200, and alerts for the selected POIs are generated for the user based upon the current service area in which the mobile telephone 100 detects itself to be. Depending upon the implementation used, the majority of the user input/output (I/O) may be offloaded onto the PDA 200, or the mobile telephone 100. In the following, two embodiments are presented: a first, in which the majority of the user I/O functionality is loaded into the PDA 200 and the mobile telephone 100 is simply used as a rough positioning device, and a preferred embodiment in which the PDA 200 is used almost solely as a POI server, with the majority of the user I/O provided by the mobile telephone 100. As should be clear to one reasonably skilled in the art after reading the following detailed descriptions, the two embodiments are simply extreme-case implementations, with variations between the two extremes certainly possible.

The mobile telephone 100 is in wireless communications with a network of base stations 3000, 4000 in a standard manner. Each base station 3000, 4000 covers a corresponding service area, and broadcasts unique base station identification information 3100, 4100, respectively. The base station identification information 3100, 4100 is a standard service broadcast freely by all base stations 3000, 4000, and so does not require any subscription fees on the part of the user of the mobile telephone 100. The mobile telephone 100 may selectively camp on one of the base stations 3000, 4000 in a manner familiar to those in the art of wireless telephony.

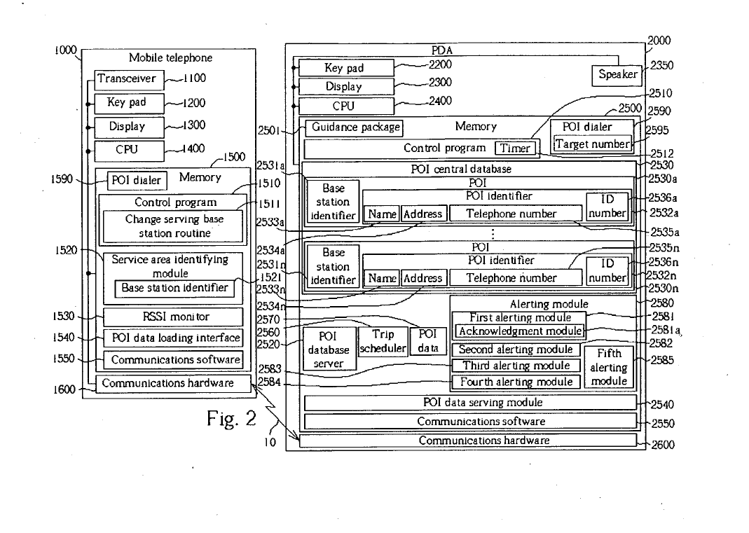

Please refer to FIG. 2. FIG. 2 is a block diagram of a first embodiment of the present invention in accordance with the arrangement depicted in FIG. 1: A first embodiment mobile telephone 1000 includes a transceiver 1100 for sending and receiving wireless signals with the network of base stations 3000, 4000. The mobile telephone 1000 also includes a keypad 1200 to accept input from a user, such as telephone numbers to be called; a display 1300 to provide visual output to the user; memory 1500 for storing programs and data; communications hardware 1600 to establish the communications link 10, and a central processing unit (CPU) 1400 to control operations of the mobile telephone 1000. The CPU 1400 is electrically connected to, and able to control and receive information from, the transceiver 1100, the keypad 1200, the display 1300 and the communications hardware 1600 in a manner well known to those in the art. The CPU 1400 is also electrically connected to the memory 1500, and is in turn controlled by programs residing within the memory 1500. The memory 1500 may be a combination of volatile and non-volatile memory. For purposes of the present invention, only the non-volatile region of the memory 1500 is considered.

A control program 1510 provides the major functionality of the mobile telephone 1000, and may be thought of as the “operating system” of the mobile telephone 1000. For the preferred embodiment, it is assumed that the control program 1510 provides GSM-related functionality. Other wireless standards, such as 3GPP, are also applicable to the present invention, and GSM is assumed for exemplary purposes only. Under the direction of the conventional control program 1510, other routines may be called to support the present invention, and which are described in detail in the following. Coding such routines should be routine for one reasonably skilled in the art after reading the following detailed description.

An aspect common to all mobile telephony is that of the mobile telephone 1000 roaming about and consequently switching from one base station 3000 to another base station 4000. To enable the mobile telephone 1000 to switch base stations 3000, 4000, each base station 3000, 4000 transmits respective base station identification information 3100, 4100 that is utilized by the control program 1510, and specifically by a change serving base station routine 1511 in the control program 1510.

For example, the mobile telephone 1000 may be initially camped on the first base station 3000. As the mobile telephone 1000 roams closer to the second base station 4000, a decision is eventually made to cause the mobile telephone 1000 to camp on the second base station 4000, which is termed a handover. The change serving base station routine 1511 utilizes the base station identification information 3100, 4100 to negotiate with both the first and second base stations 3000, 4000 to realize the handover. At the end of the handover process, the mobile telephone 1000 is camped upon the second base station 4000. When the change serving base station routine 1511 performs the serving base station handover, the routine 1511 provides a mechanism to so inform other programs in the mobile telephone 1000. This mechanism, and related handover procedure, is well known to those in the art of mobile communications.

To determine the approximate geographic location of the mobile telephone 1000, it is possible to simply assume that the mobile telephone 1000 is within the service area of the current serving base station 3000, 4000 (i. e., the base station 3000, 4000 upon which the mobile telephone 1000 is currently camped). By monitoring handovers as provided by the change serving base station routine 1511, it may be assumed with each handover that the mobile telephone 1000 is entering into the service area of the new serving base station 3000, 4000. A better approach, however, is to provide a received signal strength indicator (RSSI) monitor module 1530 that tracks the running average RSSIs of a predetermined number of base stations 3000, 4000 within the receiving range of the mobile telephone 1000. Under this scheme, it is assumed that the mobile telephone 1000 is within the service area of the base station 3000, 4000 having the highest running average RSSI. This method is preferred, as the running average RSSI is a good indicator of the physical proximity of the mobile telephone 1000 to a base station 3000, 4000, whereas the serving base station 3000, 4000 as determined by the change serving base station routine 1511 may be based upon billing concerns, and hence be a less accurate indicator of actual base station 3000, 4000 proximity. Providing such an RSSI monitor 1530 should be trivial for one reasonably skilled in the art, as such functionality is also a basic requirement of the conventional change serving base station routine 1511.

The base station information 3100, 4100 uniquely identifies each base station 3000, 4000 around the world. In the GSM standard, each base station 3000, 4000 broadcasts a Mobile Country Code (MCC), Mobile Network Code (MNC), Location Area Code (LAC) and cell ID. This combined information (MCC, MNC, LAC and cell ID) is enough to serve as unique bas station identification information 3100, 4100. For purposes of the present invention, the base station identification information 3100, 4100 may be used as is as identification information, or may be hashed to a smaller bit size to conserve space, while continuing to uniquely identify each base station 3000, 4000. Of course, if a hash function is utilized, then the hash function performed by the mobile telephone 1000 on the base station identification information 3100, 4100 must be identical to that used to generate the POI central database 2530 on the PDA 2000. This should be clear from the following discussion. Although with many variations, hashing is a commonly known programming tool, and so is not elaborated upon here.

Communications software 1550 is provided in the memory 1500 of the mobile telephone 1000 to serve as a device driver for the communications hardware 1600, and to allow other application programs in the memory 1500 to easily use the communications hardware 1600 to establish the communications link 10. In particular, within the memory 1500 there is a POI data loading interface 1540 that interfaces with the communications software 1550 to communicate with a corresponding POI data serving module 2540 on the PDA 2000. The POI data loading interface 1540 is capable of accepting portions of the POI data 2570 from the PDA 2000, and of providing positioning information 1521 to the PDA 2000. Hence, the POI data serving module 2540 on the PDA 2000 provides portions of the POI data 2570 to the mobile telephone 1000, and accepts positioning information 1521 from the mobile telephone 1000.

A service area identifying module 1520 provides the positioning information 1521 to the POI data loading interface 1540. The service area identifying module 1520 either monitors reports provided by the change serving base station routine 1511, or reports from the RSSI monitor 1530, to determine a closest base station 3000, 4000. Base station identification information 3100, 4100 obtained from that closest base station 3000, 4000 is then used to generate a unique base station identifier 1521 that serves as the current positioning information for the mobile telephone 1000. The manner used to generate the base station identifier 1521 should be consistent with corresponding base station identifiers 2531a-2531n found within the POI central database 2530 in the PDA 2000.

In this first embodiment arrangement, the purpose of the PDA 2000 is to provide the majority of the user I/O for POI tracking, as well as to provide the POI central database 2530. The PDA 2000 includes a key pad 2200, a display 2300 and a speaker 2350 for user input/output (I/O), and communications hardware 2600 to provide the communications link 10. A CPU 2400 controls the overall operations of the PDA 2000, and is in turn controlled by a control program 2510 in the memory 2500 of the PDA 2000. The control program 2510 serves as the operating system of the PDA 2000 in a conventional manner. As a portable computing device, the PDA 2000 is generally equipped with a much larger memory 2500 than that of the mobile telephone 1000, and so is much better able to store the POI central database 2530. The POI central database 2530 is stored in non-volatile memory of the PDA 2000. Communications software 2550 serves as a device driver for the communications hardware 2600, enabling other software in the memory 2500 to more easily establish and use the communications link 10. The POI data serving module 2540 runs under the control program 2510, and utilizes the communications software 2550 to interface with the POI data loading interface 1540 on the mobile telephone 1000.

The POI central database 2530 contains a plurality of POI entries 2530a-2530n. Each POI 2530a-2530n has a corresponding base station identifier 2531a-2531n. Each base station identifier 2531a-2531n uniquely identifies a base station 3000, 4000 having a service area that at least partially covers the respective POI 2530a-2530n. Base station identifier information 2531a-2531n may, in fact, simply be the base station identification information broadcast by the respective base station, or may be the hashed value of the base station identification information, as indicated above, so as to conserve space within the POI central database 2530. Each POI 2530a-2530n further contains a corresponding POI identifier 2532a-2532n that is used to identify a POI. Each POI identifier 2532a-2532n may include, for example, a name 2533a-2533n, address 2534a-2534n and telephone number 2535a-2535n of the POI 2530a-2530n, as well as an ID number 2536a-2536n that uniquely identifies the POI 2530a-2530n. Of course, a lesser or greater number of entries may be provided within the POI identifier 2532a-2532n, and is implementation specific.

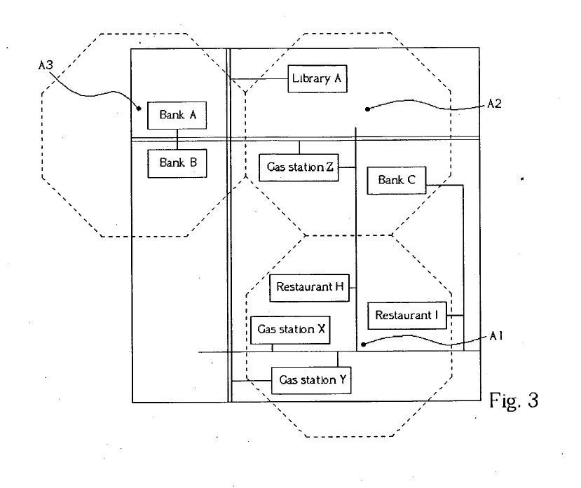

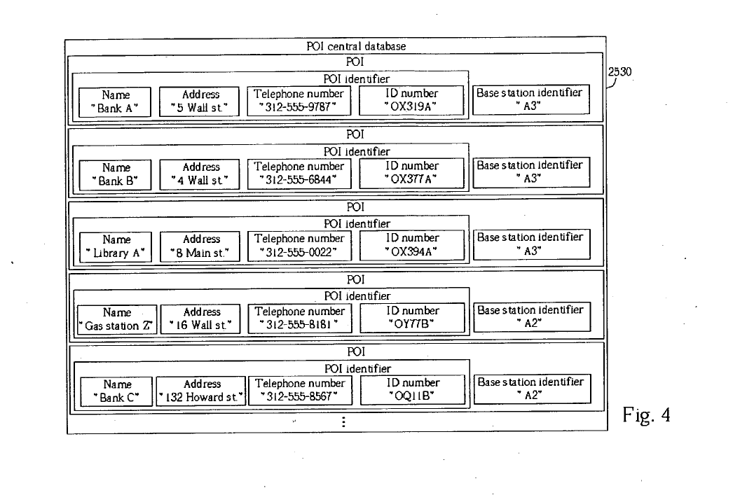

For an example implementation of the POI central database 2530, please refer to FIG. 3 and FIG. 4. FIG. 3 is a map of a hypothetical region with superimposed base station service areas. FIG. 4 illustrates a portion of a POI central database 2530 corresponding to the map of FIG. 3. In FIG. 3, three base stations A1, A2 and A3 are depicted, each with an outline of the extents of the corresponding service area. For example, the service area of base station A3 encompasses POIs “Bank A” and “Bank B”. The service area of base station A2 covers POIs “Library A”, “Gas Station Z” and “Bank C”. Each of these POIs has a corresponding entry in the POI central database 2530, as depicted in FIG. 4. Each POI entry in the POI central database 2530 is provided with a corresponding POI identifier, and a corresponding base station identifier. As shown in FIG. 4, the POI identifier is used to identify the POI, and the base station identifier indicates the base station whose service area encompasses in full or in part the POI.

The PDA 2000 also includes a POI database server 2520 that interfaces with a trip scheduler 2560 to generate POI data 2570. The POI database server 2520 accepts queries from the trip scheduler 2560, performs a search of the POI central database 2530 to find any POIs 2530a-2530n that match the supplied query, and returns those matching POIs 2530a-2530n to the trip scheduler 2560. Such functionality of the POI database server 2520 is standard in the field of database technology, and so is not elaborated upon here in any more detail, being implementation specific. The trip scheduler 2560 provides a user interface to allow the user to conveniently generate the database queries for the POI database server 2520, and to view and edit the current POI data 2570 obtained from such queries. Utilizing the trip scheduler 2560, a user may search the POI central database 2530 according to various criteria, such as name, address, telephone number, type (which may be encoded within the ID numbers 2536a-2536n, or provided in an explicit field within each POI 2530a-2530n), zip code, locale, etc. POIs 2530a-2530n found by the user are then added to the POI data 2570, along with additional information that the user may supply by way of the trip scheduler user I/O interface 2560. The trip scheduler 2560 may even provide a map-like graphical interface that shows POIs 2530a-2530n by location, and which the user may click upon to select as entries into the POI data 2570. There is an enormous number of ways in which the trip scheduler 2560 may enable the user to extract useful POI data 2570 from the POI central database 2530 (via the POI database server 2520), and elaborating upon all such possible user I/O schemas is beyond the scope of this invention, being implementation specific. Each POI 2530a-2530n extracted from the POI central database 2530 by the user will have a corresponding POI data entry within the POI data 2570, as well as zero or more alternate POI data entries, which is discussed in the following.

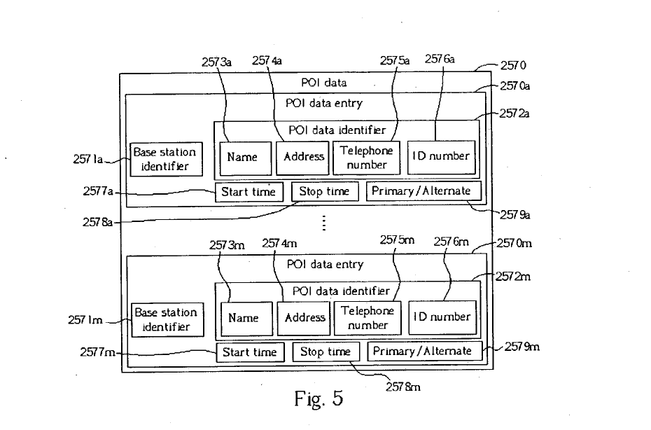

Please refer to FIG. 5. FIG. 5 is a detailed block diagram of the POI data 2570 of FIG. 2. Each POI data entry 2570a-2570m is obtained from a corresponding POI 2530a-2530n from the POI central database 2530, and respectively contains a base station identifier 2571a-2571m, a POI data identifier 25721a-2572m, a start time 2577a-2577m and a stop time 2578a-2578m. Each base station identifier 2571a-2571m is obtained from the corresponding base station identifier 2531a-2531n in the POI central database 2530. Each POI data identifier 25721a-2572m contains at least a portion of the corresponding POI identifier 2532a-2532n in the POI central database 2530. In the preferred embodiment the entire POI identifier 2532a-2532n is copied to generate the corresponding POI data identifier 25721a-2572m, and so includes name 25723a-2573m, address 2574a-2574m, telephone number 2575a-2575m and ID number 2576a-2576m fields. The start times 2577a-2577m and stop times 2578a-2578m are provided by the user by way of the trip scheduler 2560. Each POI data entry 2570a-2570m contains a primary/alternate field 2579a-2579m that is automatically generated by the trip scheduler 2560, and which indicates whether the POI data entry 2570a-2570m is a primary entry explicitly selected by the user, or an alternate entry that was automatically generated by the trip scheduler 2560. A primary entry field 2576a-2576m may point to a corresponding alternate POI data entry 2570a-2570m, and an alternate entry field 2576a-2576m may point to a corresponding primary POI data entry 2570a-2570m.

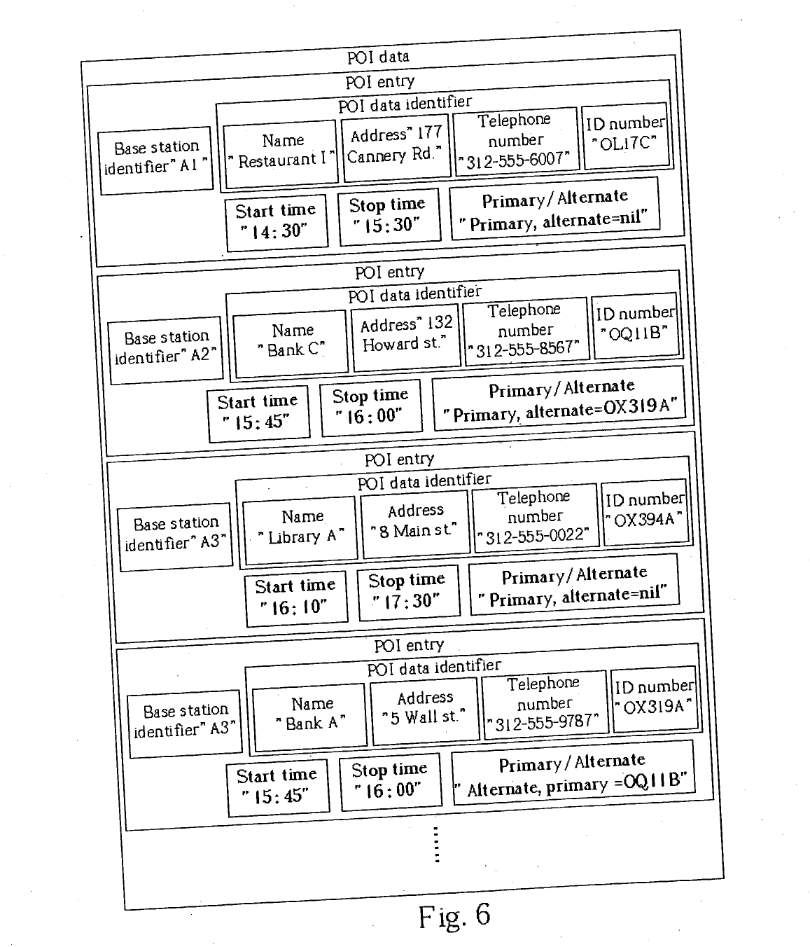

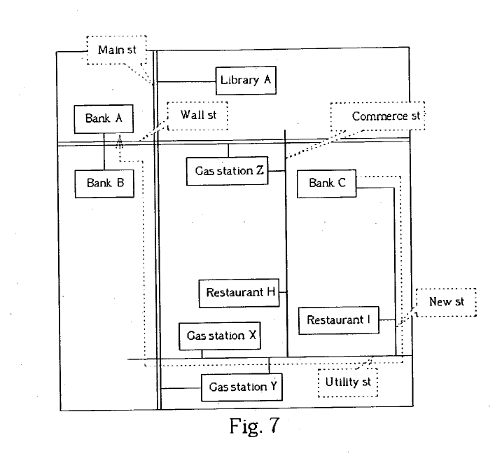

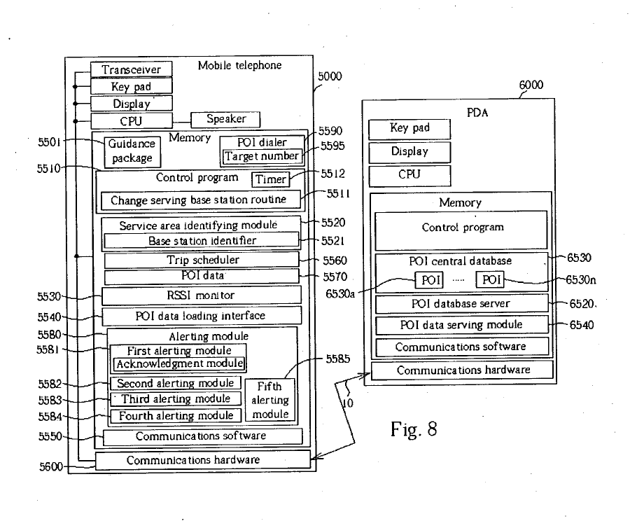

To better illustrate the above, please refer to FIG. 6, which is a block diagram of sample POI data 2570 generated by a user utilizing the trip scheduler 2560 with a POI central database 2530 for the map depicted in FIG. 3. Assume that the user has, with the trip scheduler 2560, elected to visit “Restaurant I”, “Bank C” and “Library A”. Further assume that “Bank C” and “Bank A” are branches of the same bank, and that this detailed information is contained within the respective POI identifiers in the POI central database 2530 (for example, by way of an explicit type field or the like). When the user selects “Bank C” as a destination POI, the trip scheduler 2560 automatically queries the POI database server 2520 for any POIs 2530a-2530n that are of the same type as “Bank C”. In response to this, the POI database server 2520 responds with the POI “Bank A”. Consequently, the POI data 2570 contains not three POI data entries, but four, two of which are linked together as a primary/alternate pair. The primary/alternate field for “Bank C” points to the POI data entry “Bank A”, and vice versa, by way of the respective ID numbers. Of course, it is possible to design the POI data 2570 so that one primary entry 2570a-2570m may have more that just a single alternate entry 2570a-2570m, and to devise other linking strategies rather than that of using the ID numbers 2576a-2576m.

To provide POI alerting for the user, the first embodiment PDA 2000 contains an alerting module 2580. The alerting module 2580 interfaces with the POI data serving module 2540 to obtain the most recent base station identifier 1521 as provided by the service area identifying module 1520 of the mobile telephone 1000, and utilizes the POI data 2570 to provide POI alerts to the user. As the user moves about with the mobile telephone 1000, the service area identifying module 1520 tracks the general geographic location of the mobile telephone 1000 as described above, and updates the base station identifier 1521 accordingly. With each update of the base station identifier 1521, the service area identifying module 1520 sends the new base station identifier 1521 to the POI data loading interface 1540. The POI data loading interface 1540, in turn, utilizes the communications software 1550 to send the new base station identifier 1521 to the POI data serving module 2540 via the communications link 10. In this manner, the most recent base station identifier 1521 is made available to the alerting module 2580.

The alerting module 2580 contains a first alerting module 2581 to alert the user of POIs in a new service area. When a change to the base station identifier 1521 is detected, the first alerting module 2581 scans the POI data 2570 for any entries 2570a-2570m having base station identifiers 2571a-2571m that match the current value of the new base station identifier 1521, and generates a first alert for any matching entries 2570a-2570m. The first alert may be, for example, a distinct tone generated by the speaker 2350, along with visual data presented on the display 2300 generated according to the POI data identifier 25721a-2572m of the matching POI data entries 2570a-2570m. In this manner, the user is made aware of POIs that are to be visited in the new service area. The first alerting module 2581 further contains an acknowledgment module 2581a that enable the user to acknowledge any first alerts. When a first alert is acknowledged by the user, the corresponding POI data entry 2570a-2570m is deleted from the POI data 2570, or otherwise tagged as acknowledged (for example, by setting a bit in a dedicated field within the acknowledged POI data entry 2570a-2570m). The acknowledgment module 2581a should ideally also permit a user to explicitly acknowledge any POI data entry 2570a-2570m within the POI data 2570, regardless of whether or not such an entry 2570a-2570m corresponds to the current geographical location as indicated by the base station identifier 1521. In this manner, the user can acknowledge entries 2570a-2570m at will, and as they are visited, rather than simply when a first alert is generated.

The alerting module 2580 also contains a second alerting module 2582 to alert the user of POIs that were not acknowledged in an old service area when entering into a new service area. When a change to the base station identifier 1521 is detected, the second alerting module 2582 scans the POI data 2570 for any entries 2570a-2570m having base station identifiers 2571a-2571m that match the previous (that is, old) value of the base station identifier 1521, and generates a second alert for any matching entries 2570a-2570m that have not been previously acknowledged by the user. The second alert may also be a distinct tone generated by the speaker 2350, along with corresponding visual data presented on the display 2300 as for the first alerts. In this manner, the user is made aware of POIs that were not visited in the service area from which the user is exiting.

The alerting module 2580 further contains a third alerting module 2583 to alert the user of primary POIs that have expired start times 2577a-2577m. The third alerting module 2583 tracks the start times 2577a-2577m of primary entries 2570a-2570m within the POI data 2570. Alternate entries 2570a-2570m are not considered. When the current time, as measured by a timer 2512, exceeds the start time 2577a-2577m of a primary POI data entry 2570a-2570m, a third alert is generated for that entry 2570a-2570m, which may be an audible tone, a visual cue, or a combination of the two. In this manner, POI schedule tracking is provided for the user. Optionally, at regular intervals (definable by the user), a fourth alerting module 2584 may provide a fourth alert for those primary POI data entries 2570a-2570m that have expired start times 2577a-2577m. As with the first alert, the third alert may be individually acknowledged, in which case the fourth alerts are no longer provided for such acknowledged entries 2570a-2570m. As a possible option, only primary entries 2570a-2570m that are in the current service area as defined by the base station identifier 1521 are provided third alerts.

Finally, to complete POI schedule tracking, the alerting module 2580 contains a fifth alerting module 2585 to alert the user of POIs that have expired stop times 2578a-2578m. The fifth alerting module 2585 tracks the stop times 2578a-2578m within the POI data 2570. When the current time, as measured by the timer 2512, exceeds the stop time 2578a-2578m of a primary POI data entry 2570a-2570m, a fifth alert is generated for that entry 2570a-2570m, which may be an audio/visual cue.

For a specific example of the above, consider the POI data depicted in FIG. 6. Assuming that the user first enters the service area of base station A1, a first alert is generated by the PDA 2000 for POI “Restaurant I”, indicating that POI “Restaurant I” is nearby and is to be visited. If the user then moves into the service area of base station A2 without acknowledging the first alert for POI “Restaurant I”, a second alert is generated by the PDA 2000, reminding the user that POI “Restaurant I” has not yet been visited. At the same time, new first alerts are generated for the POIs “Bank C” and “Library A”, informing the user that these two POIs are nearby and are to be visited. Assume that, for whatever reason, the user first goes to, and acknowledges the first alert for, the POI “Library A”. The POI data entry for “Library A” is then removed from the POI data 2570. If the user stays in POI “Library A” beyond 3:45 pm, which is the start time for POI “Bank C”, a third alert is generated for POI “Bank C”, informing the user that he or she is running behind schedule, and should currently be at the POI “Bank C”. Thereafter, regular fourth alert reminders are provided for POI “Bank C” by the PDA 2000 until POI “Bank C” is acknowledged as visited, or the user leaves the service area of base station A2. At 4:00 pm a final fifth alert is generated for POI “Bank C”, which is the stop time for that POI, and no further fourth alerts for POI “Bank C” are provided. When the user exits the service area of base station A2 and enters the service area of base station A3, a second alert is generated for the still-unacknowledged POI “Bank C”. At this time, the second alerting module 2582 notes that POI data entry “Bank C” has an alternate entry “Bank A”, and that POI “Bank A” is in the new service area of base station A3. The second alerting module 2582 thus informs the user that POI “Bank A” may be a suitable substitute for POI “Bank C”, and requests if the user wishes to visit the alternate POI “Bank A”. If the user confirms this, then the alternate POI “Bank A” is treated as a primary POI, and the old primary POI “Bank C” becomes an alternate for the new primary POI “Bank A”.

The PDA 2000 may optionally contain a guidance package 2501 that provides routing and direction assistance to the user. With the guidance package 2501, the user may select two POI data entries 2570a-2570m as starting and stopping points, respectively, and obtain detailed instructions on how to navigate from the starting point to the ending point. As an alternative, the user may also select POIs 2530a-2530n within the POI central database 2530 as the starting and/or stopping points. An example of this is depicted in FIG. 7, wherein the user selects the POI “Bank C” as the starting point, and the POI “Bank A” as the ending point, by way of the guidance package 2501. The guidance package 2501 utilizes the POI central database 2530 to generate a map indicating the perceived best route to get from “Bank C” to “Bank A”. The guidance package 2501 may also offer textual assistance, for example in the above by stating, “From Howard St, turn right onto New St. and proceed for 300 feet to Utility St. Turn right on Utility St. and proceed for 500 feet to Main St. Turn right on Main St. and proceed for 400 feet to Wall St. Turn left on Wall St and proceed for 100 feet. Bank A should be on your right hand side.” Although relatively complicated, the design and coding of such guidance packages 2501 is well established in the art of positioning programs.

The PDA 2000 may also be provided with a POI dialer 2590 to enable the user to initiate a telephone call with the associated telephone number of a selected POI. The POI dialer 2590 may enable a user to select a POI data entry 2570a-2570m from the POI data 2570, or may interface with the POI database server 2520 to allow the user to select a POI 2530a-2530n from the POI central database 2530. The telephone number 2535a-2535n, 2575a-2575m of the selected POI entry is copied by the POI dialer 2590 to generate a target number 2595. This target number 2595 is provided to the POI data serving module 2540 by the POI dialer 2590. The POI data serving module 2540 sends the target number 2595 to the POI data loading interface 1540 via the communications link 10. The POI data loading interface 1540 then forwards the received target number 2595 to a corresponding, POI dialer 1590 on the mobile telephone 1000. The POI dialer 1590 interfaces with the control program 1510 to cause the control program 1510 to initiate a telephone call to the target number 2595. In this manner, the user can quickly initiate a telephone call to a desired POI.

In the above-described first embodiment PDA 2000 and mobile telephone 1000, the majority of the I/O functionality and processing is performed by the PDA 2000. In the second embodiment, the majority of the I/O functionality and processing is performed by the mobile telephone. Hence, many programs that were previously designed for execution under the PDA CPU are instead designed for execution under the mobile telephone CPU. Please refer to FIG. 8. FIG. 8 is a block diagram of a second embodiment of the present invention in accordance with the arrangement depicted in FIG. 1. A second embodiment PDA 6000 continues to act as a server for a POI central database 6530, having a corresponding POI database server 6520. The POI central database 6530 has a plurality of POIs 6530a-6530n, and is functionally identical to the POI central database 2530 in the first embodiment. Similarly, the POI database server 6520 is functionally equivalent to the POI database server 2520 in the first embodiment. However, the trip scheduler 5560 is no longer present on the PDA 6000, but is instead located on the mobile telephone 5000. The trip scheduler 5560 sends database query commands to the POI data loading interface 5540, which then forwards the queries to the POI data serving module 6540 on the PDA 6000. The POI data serving module 6540 send the queries to the POI database server 6520, and then forwards responses from the POI database server 6520 back to the POI data loading interface 5540 via the communications link 10 and associated peer hardware and software. The responses from the POI database server 6520 may be in the form of one or more POIs 6530a-6530n extracted from the POI central database 6530. The responses to the database queries forwarded by the POI data serving module 6540 to the POI data loading interface 5540 are thus used to build the POI data 5570 on the mobile telephone 5000. The POI data 5570 is functionally equivalent to the POI data 2570 in the first embodiment, but is simply stored on the mobile telephone 5000 instead of the PDA 6000.

The mobile telephone 5000 continues to have a service area identifying module 5520 that optionally monitors one or both of a change serving base station routine 5511 and an RSSI monitor 5530 to obtain a base station identifier 5521 that is indicative of a current service area within which the mobile telephone 5000 is located. However, it is no longer necessary for the POI data loading interface 5540 to provide the base station identifier 5521 to the POI data serving module 6540 on the PDA 6000, as the alerting module 5580 is present on the mobile telephone 5000. The alerting module 5580 pulls the base station identifier 5521 directly from the service area identifying module 5520 to provide POI alerts to the user. To that effect, the alerting module 5581 includes first 5581, second 5582, third 5583, fourth 5584 and fifth 5585 alerting modules to respectively provide the first, second, third, fourth and fifth alerts as previously explained. The first alerting module 5581 also has an acknowledgment module 5581a that enables the user to acknowledge first alerts, and thus remove or otherwise tag POI data entries in the POI data 5570 as being visited, thus preventing second, third, fourth and fifth type alerts for these acknowledged POI data entries. Timing for the alerting module 5580 is provided by one or more timers 5512 in the control program 5510.

Finally, the second embodiment mobile telephone 5000 can include a guidance package 5501, and a POI dialer 5590. The guidance package 5501 is functionally similar to that of the first embodiment, but must negotiate with the POI database server 6520 via the communications link 10 to obtain the data needed to generate guidance instructions. Optionally, the majority of the code for determining path routing from the starting point to the ending point may be located on the PDA 6000, which simply receives the starting and ending points from the mobile telephone 5000, and then generates response data that is then forwarded to, and displayed by, the mobile telephone 5000. The POI dialer 5590 either provides its own I/O interface, or interfaces with the trip scheduler 5560, to obtain a target number 5595, as previously described. The POI dialer 5590 then interface with the control program 5510 to cause the control program 5510 to initiate a telephone call to the target number 5595.

Variations between the two above embodiments are certainly possible. One useful variation, for example, is to have the PDA provide only a sub-set of the total POI data so as to conserve memory space within the mobile telephone. That is, the POI data may be downloaded into the mobile telephone on, for example, a service region basis. For example, POI data corresponding to the current service region and all immediately surrounding service regions may be downloaded into the mobile telephone, while POI data corresponding to other regions may be cached on the PDA. The POI data loading interface on the mobile telephone, and the POI data serving module on the PDA can work together to update the sub-set of POI data on the mobile telephone as the mobile telephone roams about, and insure that the sub-set of POI data on the mobile telephone is properly synchronized with full set of POI data on the PDA.

In contrast to the prior art, the present invention utilizes publicly available base station identification information, in conjunction with RSSI values and/or camping information, to determine a general location of a user via a cellular device. A portable computing platform, networking with the cellular device, serves as a POI data server. POI alerts, based upon user-generated POI data, are provided as the cellular device roams between base station service areas, and are further provided in a time-wise manner for scheduling purposes. The POI alerts may be generated by the portable computing platform, or by the cellular device.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for providing point of interest (POI) alerting to a user of a cellular device, the cellular device capable of connecting with a network of base stations, each base station covering a corresponding service area, the method comprising:
enabling the user to select at least a first POI;
determining a first base station having a first service area that at least partially covers the first POI;
utilizing the cellular device to determine when the user enters into the first service area; and
in response to the cellular device entering into the first service area, providing a first alert to the user about the first POI.

2. The method of claim 1 wherein utilizing the cellular device to determine when the user enters into the first service area comprises:
the cellular device tracking a received signal strength indicator (RSSI) of the first base station and a corresponding RSSI of a second base station that is within the receiving range of the cellular device; and
determining the RSSI of the first base station exceeds the corresponding RSSI of the second base station.

3. The method of claim 2 wherein the RSSIs are running average RSSIs.

4. The method of claim 1 wherein utilizing the cellular device to determine when the user enters into the first service area comprises detecting the cellular device camping on the first base station.

5. The method of claim 1 further comprising enabling the user to acknowledge the first alert.

6. The method of claim 5 further comprising:
determining when the cellular device exits the first service area; and
in response to exiting the first service area, providing a second alert to the user for the first POI;

7. The method of claim 6 further comprising providing the second alert to the user only if the first alert is not acknowledged.

8. The method of claim 1 further comprising:
providing the first POI with a start time; and
providing a third alert to the user when the start time is exceeded.

9. The method of claim 8 further comprising providing a fourth alert to the user at regular intervals when the start time is exceeded.

10. The method of claim 1 further comprising:
providing the first POI with a stop time; and
providing a fifth alert to the user when the stop time is exceeded.

11. The method of claim 1 wherein enabling the user to select the at least first POI and determining the first base station having the first service area that at least partially covers the first POI comprises:
providing a computing platform comprising a POI database and associated server, the POI database containing a plurality of POIs and associating each POI with a base station identifier that uniquely identifies a base station having a corresponding base station area that at least partially covers the POI;
providing a communications link between the cellular device and the computing platform;
providing a trip scheduler that enables the user to interface with the POI database and associated server to select the first POI and generate related POI data, the POI data including a POI identifier for the first POI and a first base station identifier corresponding to the first base station;
providing a POI data loading interface on the cellular device to load the POI data into memory of the cellular device; and
utilizing the communications link and the POI data loading interface to send at least a portion of the POI data to the cellular device;
wherein the first base station transmits first base station identification information that corresponds to the first base station identifier.

12. The method of claim 11 wherein the computing platform is a portable computing platform.

13. The method of claim 11 further comprising:
providing an entry in the POI database to associate a first telephone number with the first POI;
extracting the first telephone number from the POI database according to the first POI;
utilizing the communications link and the POI data loading interface to send the first telephone number to the cellular device; and
providing a POI dialer to enable the user to call the first telephone number with the cellular device by selecting the first POI.

14. A point of interest (POI) alerting system comprising:
a cellular device; and
a portable computing platform;
the cellular device comprising:
a first central processing unit (CPU);
first communications circuitry to enable the first CPU to communicate with the portable computing platform; and
a first memory to provide first program code and working data to the first CPU, the first program code executable by the first CPU and including:
a POI data loading interface for loading POI data into the first memory of the cellular device, the POI data received from the portable computing platform via the first communications circuitry; wherein the POI data includes at least a first POI identifier with an associated first base station identifier corresponding to a first base station;
a service area identifying module for monitoring base stations to determine if the cellular device enters into a first service area of the first base station; and
a first alerting module for causing a first alert to be provided about the first POI according to the POI data when the service area identifying module indicates that the cellular device has entered into the first service area;
the portable computing platform comprising:
a second central processing unit (CPU);
second communications circuitry to enable the second CPU to communicate with the cellular device; and
a second memory comprising:
a POI database containing a plurality of POIs and associating each POI with a base station identifier that uniquely identifies a base station having a corresponding base station area that at least partially covers the POI;
a POI database server executable by the second CPU to extract the POI data from the POI database according to provided queries; and
a POI data serving module executable by the second CPU for providing the POI data to the cellular device via the second communications circuitry.

15. The POI alerting system of claim 14 wherein the first program code further comprises an acknowledge module to enable acknowledgment of the first alert for the first POI.

16. The POI alerting system of claim 15 wherein the service area identifying module is further capable of determining when the cellular device exits the first service area, and the first program code further comprises a second alerting module for providing a second alert for the first POI according to the POI data in response to exiting the first service area.

17. The POI alerting system of claim 16 wherein the second alerting module only provides the second alert for the first POI if the first alert for the first POI is not acknowledged.

18. The POI alerting system of claim 14 wherein the first memory further includes a start time associated with the first POI identifier, and the first program code further includes a third alerting module for providing a third alert when the start time is exceeded.

19. The POI alerting system of claim 18 wherein the first program code further includes a fourth alerting module for providing a fourth alert at regular intervals when the start time is exceeded.

20. The POI alerting system of claim 14 wherein the first memory further includes a stop time associated with the first POI identifier, and the first program code further includes a fifth alerting module for providing a fifth alert when the stop time is exceeded.

21. The POI alerting system of claim 14 wherein the first program code further includes a trip scheduler to enable a user to interface with the POI database server via the first communications circuitry to generate queries to extract the POI data.

22. The POI alerting system of claim 14 wherein the second memory further includes a trip scheduler executable by the second CPU to enable a user to interface with the POI database server to generate queries to extract the POI data.

23. The POI alerting system of claim 14 wherein the first program code further comprises a POI dialer to enable a user to call a first telephone number associated with the first POI identifier.

24. A point of interest (POI) alerting system comprising:
a cellular device; and
a portable computing platform;
the cellular device comprising:
a first central processing unit (CPU);
first communications circuitry to enable the first CPU to communicate with the portable computing platform; and
a first memory comprising:
a POI data loading interface for interfacing with corresponding software on the portable computing platform via the first communications circuitry; and
a service area identifying module for monitoring base stations to determine a current service area of the cellular device;
the portable computing platform comprising:
a second central processing unit (CPU);
second communications circuitry to enable the second CPU to communicate with the cellular device; and
a second memory comprising:
a POI database containing a plurality of POIs and associating each POI with a base station identifier that uniquely identifies a base station having a corresponding base station area that at least partially covers the POI;
a POI database server executable by the second CPU to extract POI data from the POI database according to provided queries; and
a POI data serving module executable by the second CPU for interfacing with the POI data loading interface via the second communications circuitry.

25. The POI alerting system of claim 24 wherein the first memory further comprises an alerting module to provide a first POI alert according to the POI data obtained by the POI data loading interface from the portable computing platform, the first POI alert further determined according to the current service area.

26. The POI alerting system of claim 24 wherein the second memory further comprises an alerting module to provide a first POI alert according to the current service area obtained by the POI data serving module from the cellular device, the first POI alert further determined according to the POI data.

27. The POI alerting system of claim 24 wherein the first memory further includes a trip scheduler executable by the first CPU to enable a user to interface with the POI database server via the first communications circuitry to generate queries to extract the POI data.

28. The POI alerting system of claim 24 wherein the second memory further includes a trip scheduler executable by the second CPU to enable a user to interface with the POI database server to generate queries to extract the POI data.

29. The POI alerting system of claim 24 wherein the first memory further comprises a POI dialer to enable a user to call a first telephone number contained in the POI data.
